(19) United States
(12) Patent Application Publication
(10) Pub. No.: US 2016/0037119 A1
(43) Pub. Date: Feb. 4, 2016

(54) VIDEO RECORDING APPARATUS, AND VIDEO RECORDING METHOD WHEN TEMPORARY NETWORK FAILURE OCCURS

(71) Applicant: IDIS CO., LTD., Daejeon-si (KR)

(72) Inventors: Jin Hui PARK, Seongnam-si (KR); Hee Lock JUNG, Hwaseong-si (KR)

(73) Assignee: IDIS CO., LTD., Daejeon-si (KR)

(21) Appl. No.: 14/609,555

(22) Filed: Jan. 30, 2015

(30) Foreign Application Priority Data
Jul. 30, 2014 (KR) 10-2014-0097608

(51) Int. Cl. H04N 5/76; H04N 5/247; H04N 17/00; H04N 7/18

(52) U.S. Cl. CPC H04N 5/7605; H04N 7/183; H04N 5/247; H04N 17/004

(57) ABSTRACT

A video recording apparatus receives real-time video data from the network camera and records the received data in a disc bank. In the apparatus, once the network is recovered from a temporary failure, a backup recording region is secured in the bank, with the size of the backup recording region corresponding to the size of video data captured by the network camera during the network failure. Then, real-time video data is recorded in a region next to the backup recording region, and video data recorded in the network camera is recorded in the backup region.

### CROSS-REFERENCE TO RELATED APPLICATION(S)

This application claims priority from Korean Patent Application No. 10-2014-0097608, filed on Jul. 30, 2014, in the Korean Intellectual Property Office, the entire disclosure of which is incorporated herein by reference for all purposes.

### BACKGROUND

1. Field

The following description generally relates to a video recording technology for recording network videos, and more particularly to a video recording technology for recording videos when a network failure occurs.

2. Description of the Related Art

Korean Patent No. 10-0468276 provides a method of preventing disc segmentation in such a manner that disc storage space is divided into a plurality of banks having a specific size, and only index information on files recorded in the banks is changed to repeatedly use (overwrite) the banks.

Various types of networks may be used for connection between network video recording equipment and a network camera. Accordingly, if a temporary network failure occurs, or if there is network bandwidth shortage, videos may not be transmitted in some cases.

### SUMMARY

Disclosed is a video recording apparatus that may minimize waste of storage space.

In one general aspect, there is provided a video recording apparatus having a storage where video data received from a network camera is recorded and that includes a plurality of banks, the apparatus comprising: a first real-time recording component, a backup information receiver, a backup recording region securing component, a second real-time recording component, and a backup recording component. The first real-time recording component is configured to receive real-time video data from the network camera and to record the received data in the plurality of banks. Once a network failure occurs while the real-time video data is recorded in the plurality of banks, the backup information receiver is configured to receive information on the size of substitute data which is video data captured by the network camera from a point where the network failure occurs to a point where the network is recovered from the failure. Based on the received information on the size of substitute data, the backup recording region securing component is configured to secure a storage region required for recording the substitute data in the plurality of banks as a backup recording region. Once the network is recovered from the failure, the second real-time recording component is configured to record the real-time video data received from the network camera in the plurality of banks in real time in a region next to the backup recording region. The backup recording component is configured to receive the substitute data and to record the received data in the backup recording region.

The second real-time recording and the backup recording may be performed at the same time.

Two write caches may be used while the second real-time recording and the backup recording are performed at the same time.

The size of the backup recording region may be a multiple of a size of the write cache.

The video recording apparatus may further include a valid index range updater, which upon starting the second real-time recording, is configured to update a range from a starting point of the first real-time recording to a point where the second real-time recording is performed as a valid index range within which real-time retrieval is enabled, wherein the valid index range updater determines the backup recording region to be an invalid range where retrieval is not enabled until the backup recording is complete.

The valid index range updater updates a range where the backup recording is complete as a valid index range when the backup recording is stopped while the backup recording is performed.

The video recording apparatus may further include a meta information updater configured to separately provide time table information on the backup recording region while the backup recording is performed, and once the backup recording is complete, configured to incorporate the time table information on the backup recording region into time table information for the real-time recording.

In another general aspect, there is provided a video recording method of a video recording apparatus that comprises a storage having a plurality of banks, the method comprising: first real-time recording wherein real-time video data is received from a network camera; once a network failure occurs while the real-time video data is recorded in the plurality of banks, receiving information on the size of substitute data which is video data captured by the network camera from a point where the network failure occurs to a point where the network is recovered from the failure; securing the backup recording region, wherein based on the received information on the size of substitute data, a storage region required for recording the substitute data in the plurality of banks is secured as a backup recording region; second real-time recording, wherein once the network is recovered from the failure, the real-time video data received from the network camera is recorded in real time in the plurality of banks in a second real-time recording region next to the backup recording region; and backup recording wherein the substitute data is received and the received data is recorded in the backup recording region.

### BRIEF DESCRIPTION OF THE DRAWINGS

FIG. 1 is a block diagram illustrating a network video recording system according to an exemplary embodiment.

FIG. 2 is a block diagram illustrating a video recording apparatus according to an exemplary embodiment.

FIG. 3 is a diagram explaining a method of recording video data in banks after recovering from a network failure according to an exemplary embodiment.

FIG. 4 is a diagram explaining a method of preventing loss of recorded data according to an exemplary embodiment.

FIG. 5 is a diagram explaining update of a valid index range during backup recording according to an exemplary embodiment.

FIG. 6 is a diagram explaining update of a valid index range when backup recording is stopped.

FIG. 7 is a flowchart illustrating a video recording method according to an exemplary embodiment.

FIG. 8 is a flowchart illustrating a method of updating a valid index range according to an exemplary embodiment.

FIG. 9 is a flowchart illustrating a method of updating meta information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

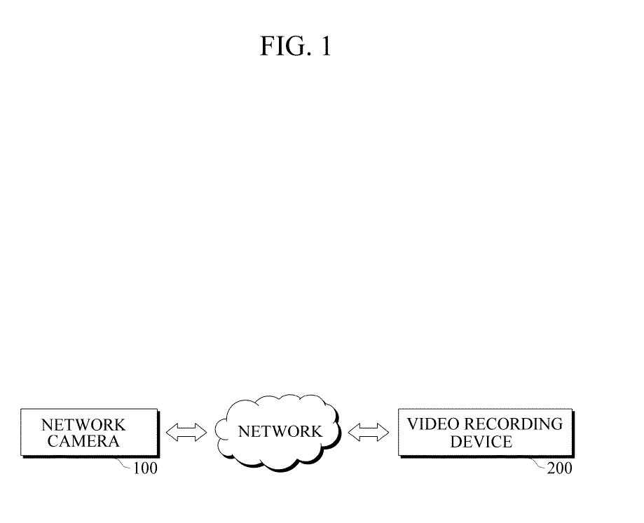

FIG. 1 is a block diagram illustrating a network video recording system according to an exemplary embodiment. As illustrated in FIG. 1, the network video recording system includes a network camera 100 and a video recording device 200. The network camera 100 is an IP camera that may be used by being connected to a wired or wireless Internet, and may include a camera module, a decoder, a video compression chip, a CPU, and a network transmission chip. The video recording device 200 records in disc storage space video data received in real time from the network camera 100. In an exemplary embodiment, the video recording device 200 may prevent disc segmentation by creating in advance banks having a specific size, and by changing only index information on files recorded in the banks, so as to repeatedly use (overwrite) the banks. The method of preventing disc segmentation is disclosed in detail in Korean Patent No. 10-0468276 which was filed by the same Applicant of the present disclosure and registered. In sum, a disc includes a plurality of banks that have index files and data files, in which the index file includes information associated with video data, such as creation time, size, types, and the like, of video data, and information on storage locations; and the data file includes the index information and video data. Fast retrieval may be enabled by separately providing the index information. By only reading the index information, stored video data may be obtained, such that shortcut functions regarding video data at a desired time may be provided at a fast speed.

Various types of networks may be used for connection between the network camera 100 and the video recording device 200. Accordingly, if there is a temporary network failure occurs, or if there is network bandwidth shortage, videos may not be transmitted in some cases. In an exemplary embodiment, the network camera 100 stores videos captured during a network failure in a system memory or in an embedded storage (e.g., SD card, etc.) of a camera. Hereinafter, recording in an embedded storage by a network camera will be referred to as substitute recording. Upon recovering from a network failure, the network camera 100 transmits data obtained by the substitute recording (hereinafter referred to as substitute data) to the video recording device 200. The video recording device 200 receives not only real-time video data but also substitute data that has not been received due to a network failure, and records the data in a disc bank. Hereinafter, obtaining and recording of the substitute data by the video recording device 200 will be referred to as backup recording.

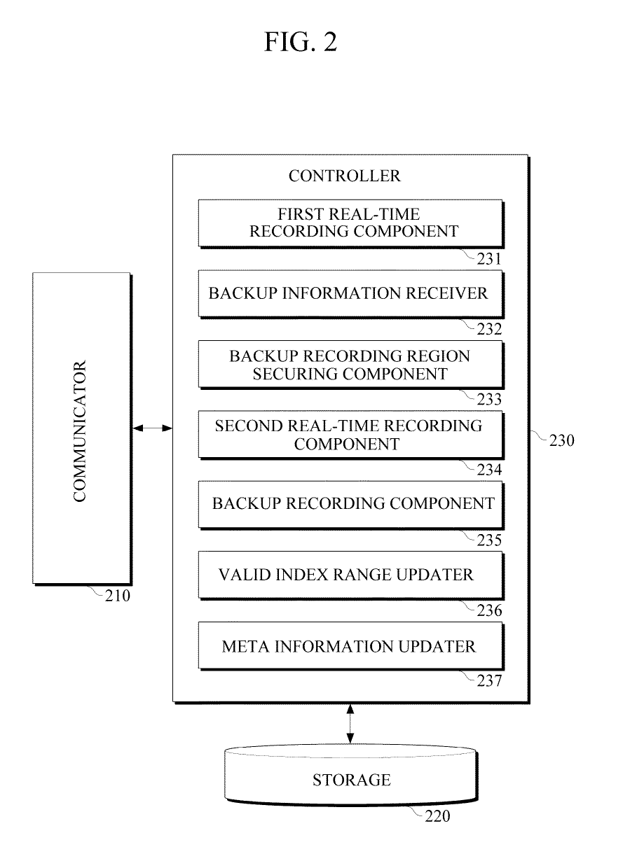

The video recording device 200 uses a binary search algorithm to move video data recorded at a specific time to a stored location when retrieving a video. To this end, all the banks are required to be arranged in a time sequence, and the time of data stored in each bank should not overlap with each other. Due to these limitations, a method that uses a new bank to back up substitute data may be considered, but the method may result in waste of storage space, which will be described with reference to FIG. 2. In the case where a network failure occurs for about 1 minute while using bank 1 for real time recording, backup recording and real-time recording are required to be recorded in new banks of bank 2 and bank 3 respectively when recording is resumed. In this case, however, an available space in bank 1 and a space remaining after the backup recording of about 1 minute are all wasted. If real-time recording is recorded in bank 1 to prevent waste of a remaining space and to use an available space of bank 1, a recording time of the one-minute backup recording recorded in bank 2 overlaps with a recording time of bank 1, such that a binary search algorithm may not be used. Even in an improved case where a recording location of video data is changed such that the backup recording is recorded in bank 1, and the real-time recording is recorded in a new bank, an available space in bank 1 that remains after recording the backup recording is still wasted. Further, in the case where network failure and recovery are repeated several times during a short period of time, a recording space is wasted at a non-negligible level.

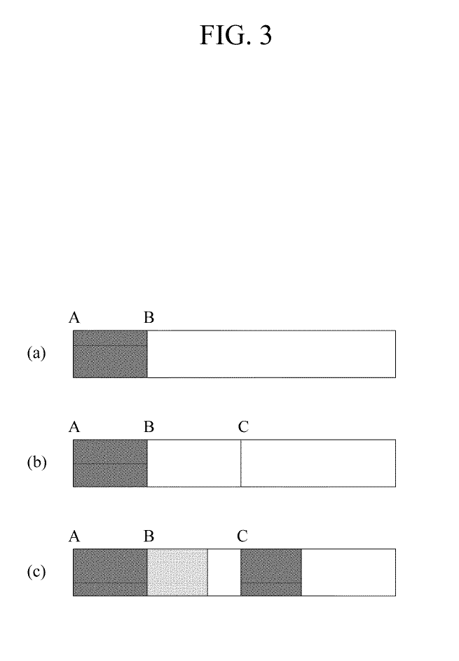

In order to overcome the drawback, the video recording device 200 according to an embodiment receives information on a number of images in substitute data, the entire size of the data, and the like, from the network camera 100, and secures in advance a space that is required for backup recording, and records a real-time video in a remaining space other than the secured space, which will be described with reference to FIGS. 2 and 3 below.

FIG. 2 is a block diagram illustrating a video recording apparatus according to an exemplary embodiment, and FIG. 3 is a diagram explaining a method of recording video data in banks after recovering from a network failure according to an exemplary embodiment. A communicator 210 is a communication module for communication between the network camera 100 and a network. A storage 220 is a storage medium where video data received from the network camera 100 is stored, and may include a disc that includes a plurality of banks having a specific size. A controller 230 may be a processor that records in the storage 220 video data received from the network camera 100. As illustrated in FIG. 2, the controller 230 includes a first real-time recording component 231, a backup information receiver 232, a backup recording region securing component 233, a second real-time recording component 234, and a backup recording component 235. Further, the controller 230 may further include a valid index range updater 236 or a meta information updater 237. The components may be software function modules, each of which performs a determined task.

The first real-time recording component 231 receives real-time video data from the network camera 100 and records the received data in a bank. As illustrated in FIG. 3 (a), video data is recorded in sequence from point A which is a starting point of a bank 210. While a network failure occurs when recording video data, the first real-time recording component 231 stops recording of the video data. After recovering from the network failure, the network camera 100 transmits information on the size of substitute data stored in an embedded storage to the video recording device 200, and the backup information receiver 232 of the video recording device 200 receives the information on the size of substitute data. Based on the received information on the size of substitute data, the backup recording region securing component 233 secures storage space required for recording the data in a bank as a backup recording region. In FIG. 3 (b), a backup recording region is from point B, where the first real-time recording component 231 stops recording, to point C.

Upon recovering from a network failure, the second real-time recording component 234 records in a bank in real time video data received in real time from the network camera 100. The second real-time recording component 234 records video data in a region (second real-time recording region) next to the backup recording region. Recording is performed in sequence from the starting point of the second real-time recording region, such that the second real-time recording component 234 records real-time video data in sequence from point C. Then, the back recording component 235 receives substitute data from the network camera 100, and records the received data in sequence from point B in a backup recording region. In an exemplary embodiment, as illustrated in FIG. 3 (c), the backup recording component 235 receives substitute data from the network camera 100, and records the received data in a backup recording region, as soon as real-time recording is performed by the second real-time recording component 234.

A disc I/O is a bottleneck point when operating a recording system in the video recording device 200. By properly controlling the disc I/O not to be performed frequently, performance of a recording system may be improved. To this end, the recording system uses a cache memory. Due to the characteristics of the video recording device 200 that sequentially records data of each file in a bank, one write cache is used for one file. However, in the case where real time recording and backup recording are performed at the same time in one bank, recording is performed in two locations on a disc, such that cache efficiency is significantly reduced when using only one write cache. This is because in order to record data of a different location in a write cache that includes data corresponding to a specific location of a file, data in the existing cache is required to be reflected in the disc. However, as described above, frequent disc I/O operations may result in reduced performance. Accordingly, in an exemplary embodiment, the controller 230 uses one write cache during first real-time recording, and uses two write caches temporarily while second real-time recording and backup recording are performed at the same time. That is, the second real-time recording component 234 uses a write cache for real-time recording, and the backup recording component 235 uses a separate cache for backup recording.

Generally, a cache is used in such a manner that data of a specific size is imported into a cache from a disc; some portions of the data are changed in the cache; and the data of the specific size is recorded in the disc all at the same time. As data of a specific size is recorded all at the same time, if importing disc data into cache is omitted, data having a garbage value in a region that has not been changed in the cache may be recorded in a disc, thereby degrading data integrity. However, in the recording system according to the present disclosure, data is overwritten in each bank, and is recorded in sequence from a front region of a bank, and information on a valid data range is maintained, such that performance may be maximized by omitting importing of disc data into the cache.

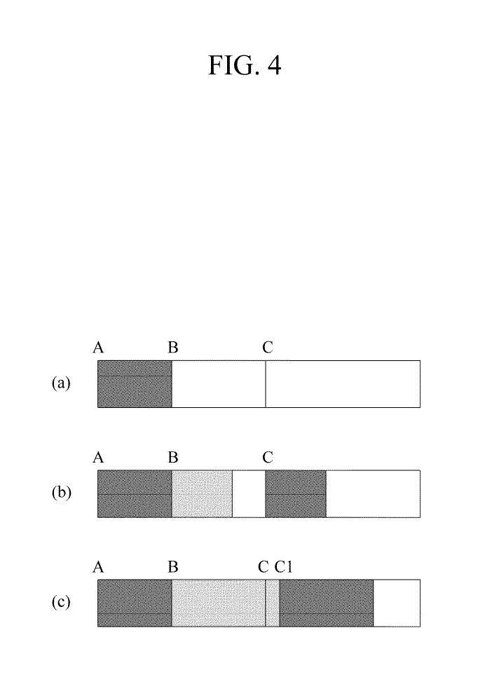

In the case where second real-time recording and backup recording are performed at the same time by using a double-write cache, an end portion of a backup recording region secured for backup recording is next to a starting location of the second real-time recording. For this reason, when data in a write cache used for the backup recording is reflected in a disc, the recorded real-time data is partially overwritten, and some portions of the real-time data may be lost, which will be described in detail with reference to FIG. 4 for better understanding. It is assumed that the size of a bank is 256 Mbytes, the size of a write cache is 1 Mbyte, and the size of substitute data is 50.7 Mbytes. The backup recording region securing component 233 checks the size of substitute data received from the network camera 100, and secures a region of 50.7 Mbytes for backup recording. The second real-time recording component 234 uses a write cache to record data with a size of 1 Mbyte from point C which is an ending point of a backup recording region, and at the same time, the backup recording component 235 uses another write cache to record data with a size of 1 Mbyte from point B which is a starting point of a backup recording region. Accordingly, as illustrated in FIG. 4 (b), data is recorded in a bank in FIG. 4 (a).

As a starting point of the second real-time recording region adjoins an ending point of the backup recording, in the case where the size of substitute data is not a multiple of the size of a write cache, real-time video data recorded in the starting portion of the second real-time recording region is overwritten with substitute data by the backup recording component 235 as illustrated in FIG. 4 (c), in which a portion that is overwritten in FIG. 4 (c) is a range of C to C1. Assuming that the size of the backup recording region is 50.7 Mbytes, and the size of the cache is 1 Mbyte, real-time video data of 0.3 Mbytes in size is overwritten with data in a write cache for backup recording. This should be prevented as real-time video data that has already been recorded may be lost. In an exemplary embodiment, the backup recording region securing component 233 secures a backup recording region, where the whole substitute data may be recorded, according to the size of the substitute data, in which the size of the backup recording region is determined to be a multiple of the size of a write cache. Referring to FIG. 4 (c), the backup recording region is required to be from point B to point C1. Accordingly, in the case where the size of the substitute recording region is 50.7 Mbytes, and the size of the write cache is 1 Mbyte, the size of the backup recording region is 51 Mbytes. As the size of the backup recording region is determined to be a multiple of the size of a cache, loss of real-time video data recorded in a starting portion of the second real-time recording region may be prevented.

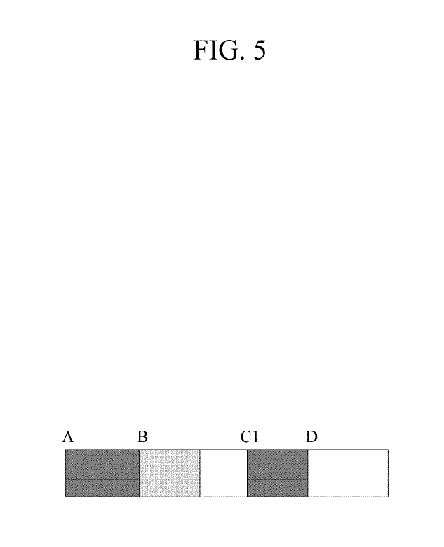

As soon as the real-time recording is performed, the video recording device 200 provides a function of retrieving real-time data. While maintaining information on a range within which valid data exists in an index file, information on a valid index range is updated to enable newly recorded data to be retrieved immediately after recording real-time data. However, as described above, upon starting to record real-time video data in the second real-time recording region that is next to the backup recording region, there exists a vacant space on an index file, in which no valid index is recorded, before backup recording is complete. Referring to FIG. 5, a valid index range is from A to D as real-time video data is recorded, but a region from B to C1 should not be used for retrieval as backup recording has not been completed.

When the controller 230 sequentially reproduces stored data, the controller 230 sequentially reads index files. When reading data in a backup recording region secured for substitute recording, a recording system may not be operated properly while reading invalid data, thereby degrading stability. To prevent the degradation, upon starting the second real-time recording, the valid index range updater 236 updates a range from a starting point of the first real-time recording to a point where the second real-time recording is performed as a valid index range within which real-time retrieval may be enabled, and determines the backup recording region to be an invalid range where retrieval is not enabled during backup recording. As illustrated in FIG. 5, the valid index range updater 236 updates a valid index range from A to B to A to D, and separately stores information indicating that a range from B to C1 is invalid for retrieval. Then, upon completing the backup recording, the valid index range updater 236 updates information on a valid index range so that the information may indicate that retrieval of a range from B to C1 is enabled. In this manner, the backup recording and the real-time retrieval may be performed at the same time in a bank.

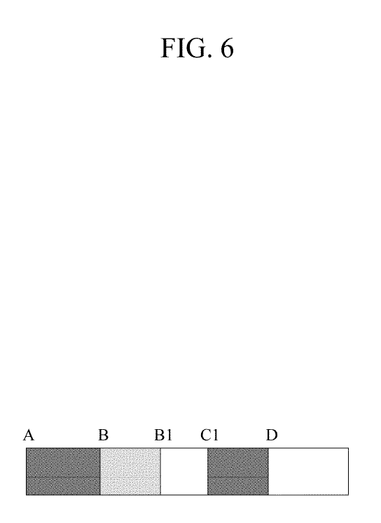

In the case where a network failure occurs again while backup recording is performed in the same manner as above, substitute recording is performed again by the network camera 100, such that, the existing substitute data may be overwritten and lost. In this case, a vacant space remains in the video recording device 200 as the entire backup recording region secured for the backup recording has not all been used. As illustrated in FIG. 6, if the backup recording is complete only in a range of B to B1 of the backup recording region, the range of B to B1 may be used for retrieval, but a range of B1 to C1 may not be used for retrieval. In this case, upon starting the backup recording, the valid index range updater 236 changes information indicating that retrieval is not enabled in a range of B to C1 to information indicating that retrieval is not enabled only in a range of B1 to C1. Accordingly, even when the backup recording is stopped during the recording, data that has already been backed up may be retrieved.

The meta information updater 237 according to an exemplary embodiment updates meta information, such as a time table about video data stored in the storage 220 and the like, at the same time when backup recording is complete. The time table refers to information on a location where video data is recorded on a time axis, i.e., information on a recording time. During the backup recording, data in the backup recording region may not be retrieved. For this reason, it is desirable to synchronize meta information such as a time table and the like, so that the information may be updated at the same time when the backup recording is complete. The meta information updater 237 separately forms/maintains time table information for backup recording, and once the backup recording is complete, the information is incorporated into time table information for real-time recording.

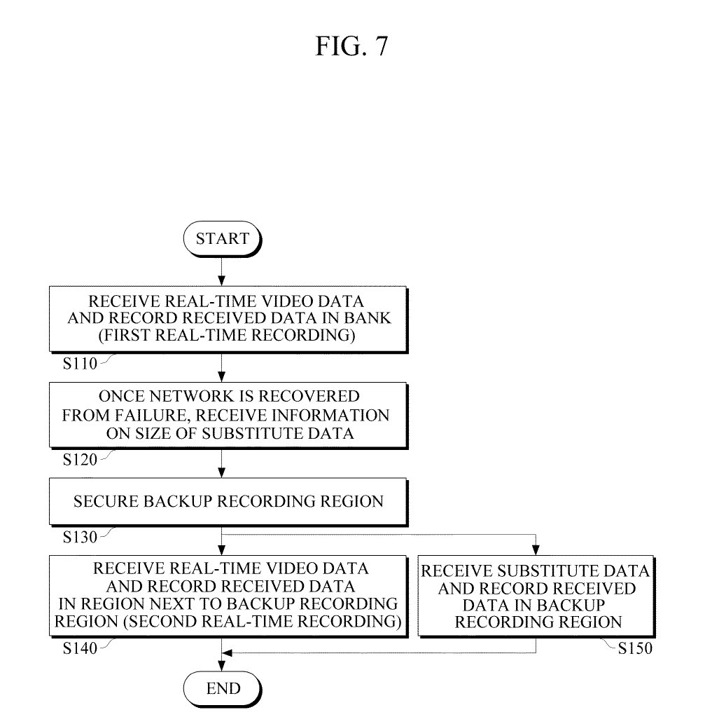

FIG. 7 is a flowchart illustrating a video recording method according to an exemplary embodiment. It is assumed in the video recording method in FIG. 7 that a network failure occurs temporarily during real-time recording, and the network is recovered. The controller 230 of the video recording device 200 receives real-time video data from the network camera 100, and records the received data in a bank in S110, which is called a first real-time recording. During the first real-time recording, once a network is recovered from a failure, the controller 230 receives from the network camera 100 information on the size of substitute data in S120. The controller 203 secures a backup recording region in a bank according to the received information on the size of substitute data in S130. In an exemplary embodiment, the controller 230 secures a backup recording region, the size of which corresponds to a multiple of the size of a write cache. In an exemplary embodiment, the controller 230 secures a backup recording region that is sufficient to record all the substitute data and is the lowest multiple of the size of a write cache. The controller 230 receives real-time data from the network camera 100 and records the received data in a second real-time recording region that is a space next to the backup recording region in S140, which is called a second real-time recording. Further, the controller 230 receives substitute data and records the data in the backup recording region in S150. In an exemplary embodiment, the controller 230 may perform S140 and S150 at the same time, and may perform S140 and S150 by using two write caches.

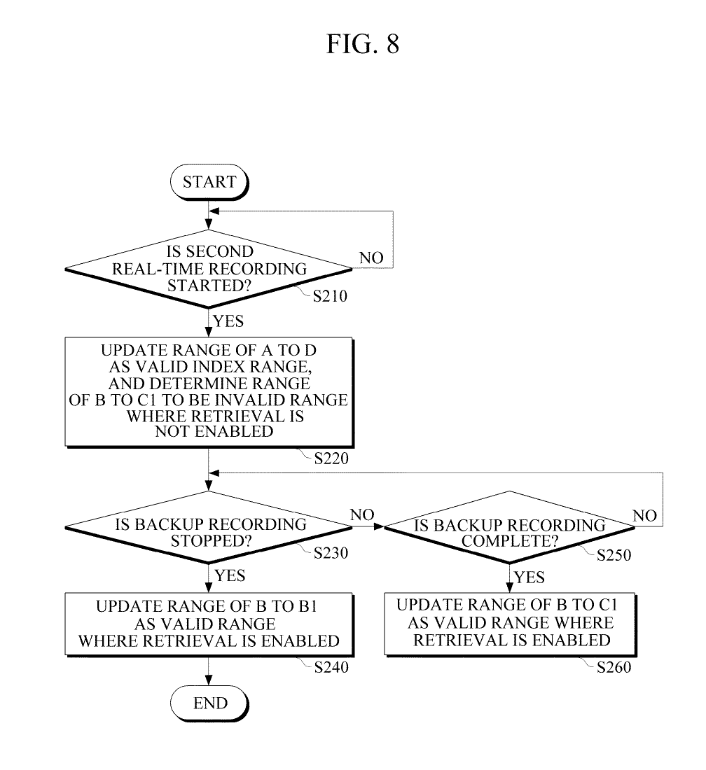

FIG. 8 is a flowchart illustrating a method of updating a valid index range according to an exemplary embodiment. The method of updating a valid index range may be included in the video recording method described above. FIG. 8 will be described with reference to FIG. 6. Upon starting second real-time recording, the controller 230 updates a range of A to D as a valid index range as soon as the second real-time recording is performed, and determines a range of B to C1 to be an invalid range where retrieval is not enabled in S210 and S220. In the case where the backup recording is stopped, the controller 230 updates a range of B to B1, in which backup recording is complete, as a valid range where retrieval is enabled in S230 and S240. Upon completing the backup recording in S250, the controller 230 updates a range of B to C1 in S260, which is a backup recording region, as a valid range where retrieval is enabled.

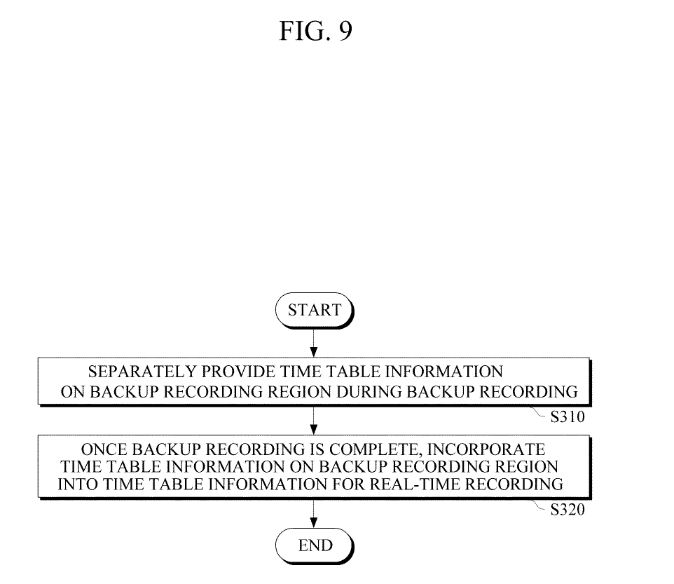

FIG. 9 is a flowchart illustrating a method of updating meta information according to an exemplary embodiment. The method of updating meta information illustrated in FIG. 9 may be included in the video recording method and the method of updating a valid index range described above. The controller 230 separately provides time table information on the backup recording region during the backup recording in S310. Upon completing the backup recording, the controller 230 incorporates the time table information for backup recording into time table information for real-time recording in S320. That is, once backup recording is complete, time table information may be updated all at the same time.

Disclosed is a video recording apparatus and video recording method, in which even when a temporary network failure occurs, all the videos during the network failure may be recorded in banks, and waste of disc storage space may be prevented.

Further, in the video recording apparatus and video recording method, substitute video data and real-time video data recorded in a network camera during a network failure may be recorded at the same time by using a double-write cache, thereby preventing degradation of recording performance.

In addition, data loss caused by a double-write cache may be prevented.

Moreover, backup recording and real-time retrieval may be performed at the same time.

Even when backup recording is failed in the course of the recording, data that are already backed up may be retrieved.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. A video recording apparatus having a storage where video data received from a network camera is recorded and that includes a plurality of banks, the apparatus comprising:
a first real-time recording component configured to receive real-time video data from the network camera and to record the received data in the plurality of banks;
a backup information receiver, which once a network failure occurs while the real-time video data is recorded in the plurality of banks, is configured to receive information on the size of substitute data which is video data captured by the network camera from a point where the network failure occurs to a point where the network is recovered from the failure;
a backup recording region securing component, which based on the received information on the size of substitute data, is configured to secure a storage region required for recording the substitute data in the plurality of banks as a backup recording region;
a second real-time recording component, which once the network is recovered from the failure, is configured to record the real-time video data received from the network camera in the plurality of banks in real time in a region next to the backup recording region; and
a backup recording component configured to receive the substitute data and to record the received data in the backup recording region.

2. The apparatus of claim 1, wherein the second real-time recording and the backup recording are performed at the same time.

3. The apparatus of claim 2, wherein two write caches are used while the second real-time recording and the backup recording are performed at the same time.

4. The apparatus of claim 2, wherein the size of the backup recording region is a multiple of a size of the write cache.

5. The apparatus of claim 4, further comprising a valid index range updater, which upon starting the second real-time recording, is configured to update a range from a starting point of the first real-time recording to a point where the second real-time recording is performed as a valid index range within which real-time retrieval is enabled, wherein the valid index range updater determines the backup recording region to be an invalid range where retrieval is not enabled until the backup recording is complete.

6. The apparatus of claim 5, wherein the valid index range updater updates a range where the backup recording is complete as a valid index range when the backup recording is stopped while the backup recording is performed.

7. The apparatus of claim 5, further comprising a meta information updater configured to separately provide time table information on the backup recording region while the backup recording is performed, and once the backup recording is complete, configured to incorporate the time table information on the backup recording region into time table information for the real-time recording.

8. A video recording method of a video recording apparatus that comprises a storage having a plurality of banks, the method comprising:
first real-time recording wherein real-time video data is received from a network camera;
once a network failure occurs while the real-time video data is recorded in the plurality of banks, receiving information on the size of substitute data which is video data captured by the network camera from a point where the network failure occurs to a point where the network is recovered from the failure;
securing the backup recording region, wherein based on the received information on the size of substitute data, a storage region required for recording the substitute data in the plurality of banks is secured as a backup recording region;
second real-time recording, wherein once the network is recovered from the failure, the real-time video data received from the network camera is recorded in real time in the plurality of banks in a second real-time recording region next to the backup recording region; and
backup recording wherein the substitute data is received and the received data is recorded in the backup recording region.

9. The method of claim 8, wherein the second real-time recording and the backup recording are performed at the same time.

10. The method of claim 9, wherein two write caches are used while the second real-time recording and the backup recording are performed at the same time.

11. The method of claim 9, wherein the size of the backup recording region is a multiple of a size of the write cache.

12. The method of claim 11, further comprising updating of a valid index range, wherein upon starting the second real-time recording, a range from a starting point of the first real-time recording to a point where the second real-time recording is performed is updated as a valid index range within which real-time retrieval is enabled, wherein the backup recording region is determined to be an invalid range where retrieval is not enabled until the backup recording is complete.

13. The method of claim 12, wherein a range where the backup recording is complete is updated as a valid index range when the backup recording is stopped while the backup recording is performed.

14. The method of claim 12, comprising:
separately providing time table information on the backup recording region while the backup recording is performed; and
once the backup recording is complete, incorporating the time table information on the backup recording region into time table information for the real-time recording.
